(19) United States
(12) Patent Application Publication
(10) Pub. No.: US 2024/0126886 A1
(43) Pub. Date: Apr. 18, 2024

(54) Trusted Computing for Digital Devices

(71) Applicant: Google LLC, Mountain View, CA (US)

(72) Inventors: Oskar Gerhard Senft, Melrose, MA (US); Miguel Angel Osorio Lozano, El Dorado Hills, CA (US); Timothy Jay Chen, Pleasanton, CA (US); Dominic Anthony Rizzo, Mountain View, CA (US)

(73) Assignee: Google LLC, Mountain View, CA (US)

(21) Appl. No.: 18/547,291

(22) PCT Filed: Feb. 24, 2021
(86) PCT No.: PCT/US2021/019399

§ 371 Date: Aug. 21, 2023

(51) Int. Cl. G06F 21/57; H04L 9/08

(52) U.S. Cl. CPC G06F 21/572; H04L 9/0825

(57) ABSTRACT

This document describes techniques and systems for providing trusted computing for digital devices. The techniques and systems may use cryptographic algorithms to provide trusted computing and processing. By doing so, the techniques help ensure authentic computation and prevent nefarious acts. For example, a method is described that receives a signature associated with a designee and validates the signature. The signature may be associated with a designee of a host computing device, and the signature may be generated according to firmware associated with an integrated circuit of the host computing device and a first private key of a first asymmetric key pair. Signature validation may be based on a second asymmetric key pair having a second private key and a second public key, the second private key stored in write-once memory of the host computing device.

### BACKGROUND

Digital computing devices are often composed of various integrated circuits. These integrated circuits may require revision from time to time. Revisions may be sourced remotely from the Internet, removable media, or another implement. To prevent nefarious and malicious acts, chip and device designers rigidly employ mechanisms to limit changes to underlying firmware.

Though they are generally secure, the aforementioned mechanisms limit the configurability of digital computing devices and the various integrated circuits. As is often the case with safeguards, security can challenge ease of use, revision, adaptation, and reworking of digital computing devices.

### SUMMARY

This document includes techniques and apparatuses for providing trusted computing for digital devices, which are directed at improving security and resiliency of computing systems. These techniques can establish trust for computing systems, thereby providing secure boot functionality and secured processing for system resources.

These techniques and systems may use cryptographic algorithms to provide trusted computing and processing. By doing so, the techniques help ensure authentic computation and prevent nefarious acts. For example, a method is described that receives a first signature associated with a designee and validates the first signature. The signature may be associated with a designee of a host computing device, and the signature may be generated according to firmware associated with an integrated circuit of the host computing device and a first private key of a first asymmetric key pair. Signature validation, when using a second asymmetric key pair, has a second private key and a second public key, the second private key stored in write-once memory of the host.

This document also describes a computer-readable medium having a digital storage. The digital storage includes a read-only, write-once partition and a non-volatile portion. The computer-readable medium may include a second private key stored on the read-only, write-once partition and a first public key stored on the non-volatile portion. A validation program, stored on the digital storage in computer-readable form, validates signatures by comparing digests signed by a private key and decrypted with a public key to digests of the original file.

Optional features of one aspect, such as the method described above, may be combined with other aspects.

This document also describes a system having a digital storage and a processor. The digital storage includes a read-only, write-once partition and a non-volatile portion. The computer-readable medium may include a second private key stored on the read-only, write-once partition and a first public key stored on the non-volatile portion. The computer-readable medium also includes a validation program stored on the digital storage in computer-readable form, which validates a received signature.

These enable a trust system to ensure trusted processing and computing on the host computing system preventing an unauthorized firmware revision from executing on an integrated circuit of the host computing device.

This summary is provided to introduce simplified concepts concerning trusted computing for digital devices, which is further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

The details of one or more aspects of providing trusted computing for digital devices are described in this document with reference to the following drawings. The same numbers are used throughout the drawings to reference like features and components:

FIG. 1 illustrates an example environment in which techniques enabling trusted computing for digital devices can be implemented in accordance with one or more implementations of the present disclosure;

FIG. 2 illustrates an example computing device in accordance with one or more implementations of the present disclosure;

FIG. 3 illustrates an example computer-readable medium in accordance with one or more implementations of the present disclosure;

FIG. 4 illustrates an example method for updating a manifest in accordance with one or more implementations of the present disclosure;

FIG. 5 illustrates an example method for restricting execution of software in accordance with one or more implementations of the present disclosure; and

FIG. 6 illustrates an example method for activating a designee in accordance with one or more implementations of the present disclosure.

### DETAILED DESCRIPTION

### Overview

An example computing system (e.g., server blade) includes various integrated circuits and hardware components mounted to a motherboard or other printed circuit board. The integrated circuits and hardware components interconnect to communicate and interact. Communication and interaction between the components may establish trust based on cryptographic mechanisms.

Assume that the computing system has various components communicating in a hierarchical structure. As an example, a root component may be associated with cryptographic keys (e.g., a public-private key pair). One or both of the keys may be stored on the root component. As an example, the root component may house the public key to provide verification of firmware signed by the private key. A signature, or endorsement, is a message that is encrypted by a private key and validated by a public key. The message may be an set of bits or a digest of the set of bits. When firmware is received by the computing system, the components downstream from the root component must receive authorization from the root component to run the firmware according to the public key.

If the private key is kept by the original equipment manufacturer or a designee, the firmware of the computing system may only be updated by the possessor of the private key. As discussed throughout this disclosure, the private key is stored on the root component or other secured storage to prevent unauthorized access and allow issuance of alternative keys as an authority designation. As an example, the primary key may be used to issue additional private-public key pairs and allow those private-public key pairs to sign and validate firmware intended for the computing system. As such, the public key associated with the root component can further validate that the private-public key pairs are legitimate and that the firmware signed and validated by the issued pair is legitimate.

As an example taught by this disclosure, the root component may keep a manifest or repository of issued and valid private-public key pairs. The manifest may maintain identifiers, public keys, and digests associated with each private-public key pair to track, update, and remove issued signatory authority for the computing system.

Such a computing system may be hardened against attack vectors as taught by this disclosure. As an example, fuses may be in place to deter physical access to the root component. The computing system may further be hardened against race conditions (e.g., time-of-check to time-of-use). As an example, the root component signs the received firmware, and the downstream component of the platform checks the signature against the public key associated with the root component. As such, intrusions are unable to perform root kits and other nefarious acts.

In this example, validation is maintained for firmware updates and hardware-component operation according to the root component. By allowing issuance of public-private key pairs after manufacture, computing systems and devices may be maintained even through end of life or end of support. Indeed, support can be seamlessly transferred to additional entities through issuance of new public-private key pairs.

In an alternative or additive example, the root component's public-private key pair may be written to the root component upon manufacture. The keys may be unique or substantially unique to the device based on the model type or model number. As an example, the keys may be generated based on a random-number generator and other hardware-component identifiers on the computing system. There may be a numeric possibility for overlap or possible intentional overlap of the key values. The key values may be further based on temporal (e.g., data-time) values or other information provided upon manufacture (e.g., location, brand, model number). An owner or designee may be a party associated with the device at manufacture or designated as a firmware steward after manufacture. As an example, a device or circuity may be manufactured by Company A only to end support of the device, or pass support of the device, to Company B. Company B may be designated as an owner or steward of one or more of the firmwares or chipsets therein and use this authorization to sign firmware updates for the device.

One example of the present disclosure includes storage of a private key on a computing system. Authority to sign and execute firmware for other components on the computing system may be based on that private key. Indeed, such application of this and other implementations provided in this disclosure increase user experience and extend device maintenance duration. These are but a few examples of how the described techniques and devices may be used to improve the security of computing systems, other examples and implementations of which are described throughout this document. The document now turns to an example operating environment, after which example devices, methods, and systems are described.

### Operating Environment

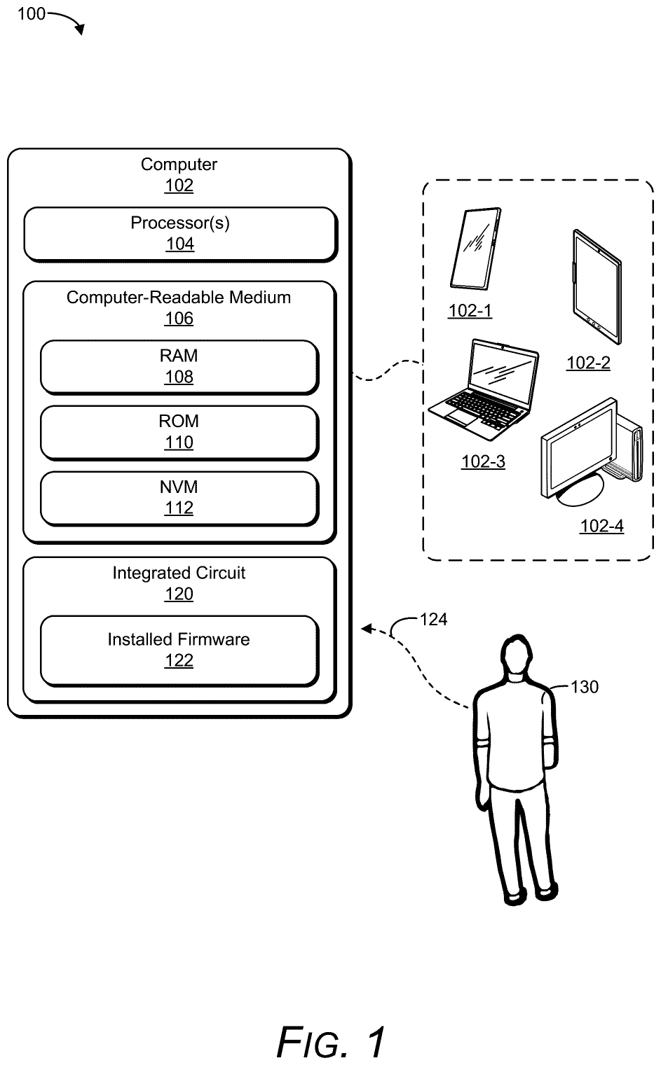

FIG. 1 illustrates an example device diagram 100 of a host computing device 102 that can authenticate and conceal data according to one or more implementations of the present disclosure. The host computing device 102 may include additional components and interfaces omitted from FIG. 1 for the sake of clarity. The host computing device 102 can be a variety of electronic devices or user devices. For example, the host computing device 102 can be a mobile phone 102-1, a tablet device 102-2, a laptop computer 102-3, a desktop computer 102-4, a server, a cloud computer, or a computational implement using digital logic.

The host computing device 102 includes one or more processors 104. The processors 104 may be of any implement and may be associated with a computer-readable medium 106. The computer-readable medium 106 may include random-access memory (RAM) 108, read-only memory (ROM) 110, or non-volatile memory (NVM) 112 and is non-transitory. One example is shown in FIG. 1 that provides secure boot and other trusted computing implements. Any combination and number of processors or computer-readable media may be used. The computer-readable medium may be located onboard or offboard the host computing device 102 or any combination thereof As an example, the computer-readable medium 106 may be a network-accessible location (e.g., cloud) or a removable device (e.g., thumb drive).

Any type of computer-readable medium 106 may be used (e.g., random-access memory (RAM), static RAM (SRAM), dynamic RAM (DRAM), non-volatile RAM (NVRAM), read-only memory (ROM), Flash memory) to store data of the host computing device 102 and provide processing buffers. The data can include an operating system, one or more applications, user data, and multimedia data. The data can include instructions in computer-readable form, including a validation program including instructions operable to implement the teachings of this disclosure. The instructions may be of any implement and may include field-programmable gate arrays (FPGA), machine code, assembly code, higher-order code (e.g., RUBY), or any combination thereof The processor may execute the instructions to follow a combination of steps and executions as provided in this disclosure.

The host computing device 102 may include an integrated circuit 120 as one of many electrical components or chips. The integrated circuit 120 may be a monolith or pseudo-monolith circuit associated with the host computing device 102. As an example, the integrated circuit 120 may be a trusted platform module (TPM). The integrated circuit may be any chips, components, circuitry, or any combination thereof associated with the host computing device 102. The integrated circuit 120 may include installed firmware 122. As an example, installed firmware 122 may include any set of instructions for operating the integrated circuit 120. The installed firmware 122 may be held in any type of memory associated with the integrated circuit 120. The installed firmware 122 may include any number of elementary or basic functions that provide services to higher-level software. A designee 130 or any other entity (e.g., user, controller) may desire to update the installed firmware 122 with revised firmware 124. The revised firmware 124 may be any type of software update to the installed firmware 122.

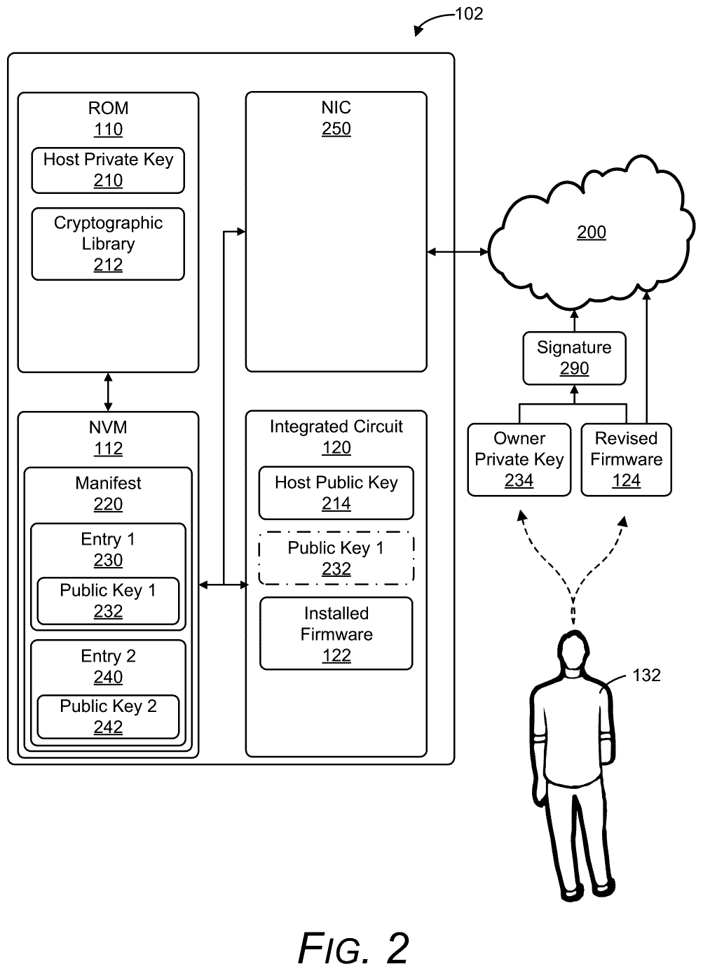

FIG. 2 illustrates an example host computing device 102 in accordance with one or more implementations of the present disclosure. A host private key 210 may be disposed on the ROM 110. The ROM 110 may be write-once memory bound to the ROM substrate through fuses or other mechanisms that prevent alteration of the ROM 110. Additionally, the ROM 110 may include tamper-evident mechanisms to lock out the host computing device 102 in the event that alteration or unauthorized access is attempted. The ROM 110 is in electrical communication with the NVM 112. The electrical communication between ROM 110 and the NVM 112 may be bidirectional, where a manifest 220 stored in the NVM 112 includes a signature signed by the host private key 210 to ensure authenticity of the manifest 220. Regarding the manifest 220, or entries therein, it may be signed by the host private key and stored in the NVM 112 with the cryptographic library 212. Concerning the cryptographic library 212, it may have isolated access to the host private key 210 and the NVM 112.

The host private key 210, and other keys discussed herein, may be of various implements. The host private key 210 may be generated using various algorithms. As an example, RSA-SHA3-512 may be used.

In an example, the cryptographic library 212 includes instructions to generate private and public keys signed by the host private key 210. The library may be open-source (e.g., OPENSSL) or closed-source. The cryptographic library 212 is used to generate a previous-designee entry 230 based on the host private key 210. The previous-designee entry 230 can be configured during manufacture and include a current-designee public key 232.

Depending on the designation status, the manifest 220 may include more than one entry 230, 240. As an example, the current-designee entry 240 includes a new designee public key 242 and provision additional keys for the new designee. The public keys 232, 242 associated with the entries 230, 240, respectively, are stored on the integrated circuit 120 to validate the revised firmware 124.

The revised firmware 124 can be issued according to a current designee 132, and the current designee 132 could be various entities that provide the revised firmware 124 for the integrated circuit 120. In an example, the current designee 132 signs the revised firmware 124 with a designee private key 234 associated with the previous-designee entry 230 and associated with the public key 232 to form designee signature 290. In other words, the designee private key 234 and the designee public key 232 are an asymmetric key pair; the designee private key 234 is used to digitally sign the revised firmware 124, thereby generating the designee signature 290. The designee signature 290 and the revised firmware 124 are sent over the Internet 200 to the network interface card 250 of the host computing device 102. On boot, the integrated circuit 120 checks the revised firmware 124 stored within the host computing device 102 to ensure the revised firmware 124 is valid, and the host public key 214 may be used to check the revised firmware 124 to ensure that the revised firmware 124 was signed by a private key endorsed by the host private key 210. The revised firmware 124 may be checked by the host public key 214 or designee public key 232 to ensure that the firmware was signed by a private key assigned to the current designee of the previous-designee entry 230.

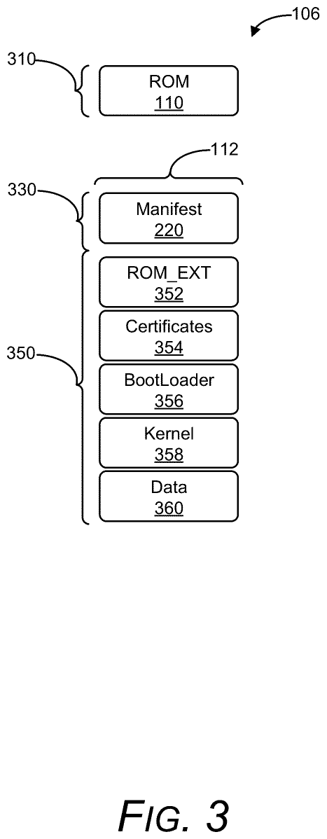

Referring to FIG. 3, an example computer-readable medium 106 in accordance with one or more implementations of the present disclosure is shown. The computer-readable medium 106 may be distributed through the host computing device 102 rather than a particular individual component. In an example, the computer-readable medium 106 includes the ROM 110, which may also include the host private key 210 and the cryptographic library 212. The computer-readable medium 106 may further include the NVM 112, which includes a flash information section 330. The flash information section 330 may house the manifest 220, including the previous-designee entry 230 and the current-designee entry 240. The computer-readable medium 106 may further include one or more flash banks 350. The flash banks 350 may store a ROM extension memory 352, designee certificate memory 354, bootloader memory 356, kernel memory 358, and other data memory 360 associated with the host computing device 102. The ROM extension memory 352 contains information stored in the NVM 112 and signed by the host private key 210. The ROM extension memory 352 may also include functions; one such function may disable access to the manifest 220 before handing over execution privileges to the next boot stage.

The ROM extension memory 352 may represent modifiable code that extends the functionality of the ROM 110. The ROM 110 may be responsible for initial bootstrap, secure boot, and security configuration. The ROM extension memory 352 may be associated with applying patches to correct hardware issues, applying security settings, and performing provisioning of keys.

The bootloader memory 356 may be signed by the designee private key 234, and the kernel memory 358 may also be signed by the designee private key 234. As such, the authenticity of information stored in the bootloader memory 356 and the kernel memory 358 may be verified by the designee public key 232. The host public key 214 may further be stored in the ROM extension memory 352 and integrity protected by a ROM extension signature signed by the host private key 210.

The keys discussed herein may be based on the integrated circuit 120 or other components associated with the host computing device 102. The keys may be derived from information associated with the integrated circuit 120. As an example, the keys may be derived from a serial number or model number of the integrated circuit 120.

### Example Methods

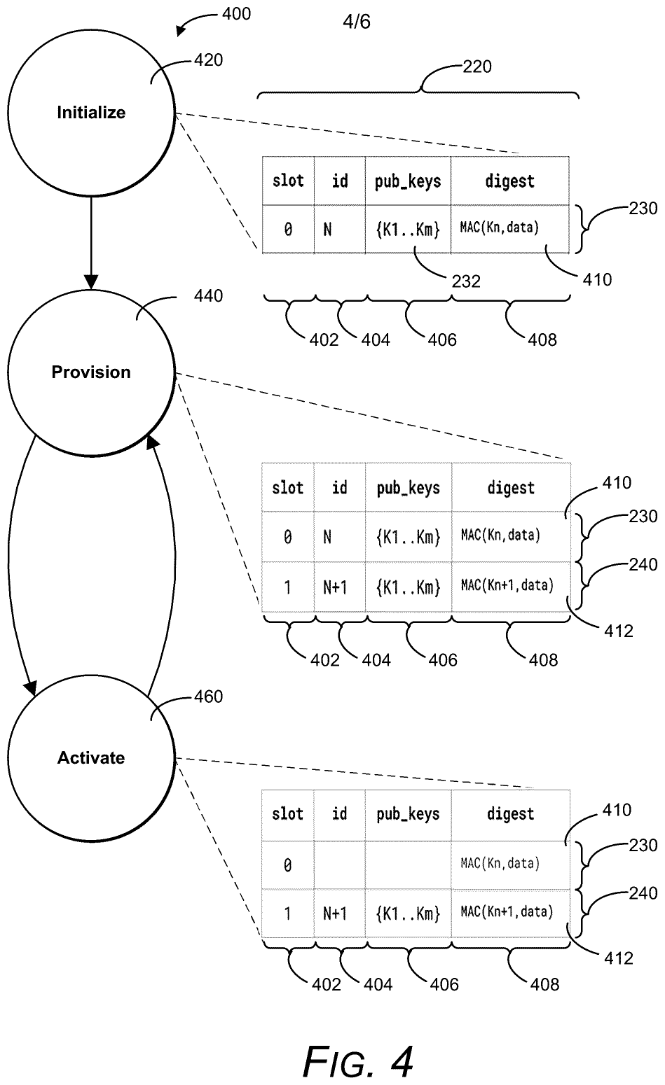

Turning to FIG. 4, an example method 400 for updating the manifest 220 in accordance with one or more implementations of the present disclosure is shown. The method 400 is shown as a set of blocks that specify operations and steps performed but are not necessarily limited to the order or combinations shown for performing the operations by the respective blocks. Further, any of one or more of the operations may be repeated, combined, reorganized, omitted, or linked to provide a wide array of additional and/or alternate methods. In portions of the following discussion, reference may be made to the examples of the preceding figures, reference to which is made for example only. The techniques are not limited to performance by one entity or multiple entities operating on one device.

The manifest 220 is shown having organizational designations corresponding to a slot designation 402, identifier designation 404, public-key repository 406, and a digest repository 408, culminating in a previous-designee entry 230 of the manifest 220. The public-key repository 406 may include the designee public key 232. The slot designation 402 may be limited to two values, assigning entries to the previous-designee entry 230 (e.g., previous or original designee) and a current-designee entry 240 (e.g., current designee). The identifier designation 404 may uniquely identify the entries 230, 240. As an example, the entries 230, 240 may be assigned an identifier that increments to correspond to each designee of the host computing system 102. The public-key repository 406 may include keys associated with the previous designee 130 and current designee 132. Continuing across thecolumns, the digest repository 408 includes a previous-designee digest 410 associated with the first entry or the previous-designee entry 230. The previous-designee digest 410 may be a message authentication code (MAC), keyed-hash message authentication code (HMAC), or another type of integrity and authenticity function.

The previous-designee digest 410 may be based on a symmetric key managed by the cryptographic library 212. The symmetric key is provisioned during manufacture and stored in the write-once storage of the ROM 110. In the instance where the previous-designee digest 410 is associated with a previous-designee entry 230, the current-designee digest 412 associated with the current-designee entry 240 may be based on the previous-designee digest 410 in an effort to bind the key to the custody chain.

During an initialization step 420, the host computing device 102 may generate the previous-designee entry 230 with functions stored in the ROM 110 and the ROM extension memory 352. A provision step 440 issues an additional entry or the current-designee entry 240 to the manifest 220, including public keys associated with the current designee 132, to validate signatures signed by the designee private key 234. An activation step 460 issues the manifest 220 with only one activated entry, the current-designee entry 240. The previous-designee entry 230 is deleted from the manifest 220 or otherwise inactivated.

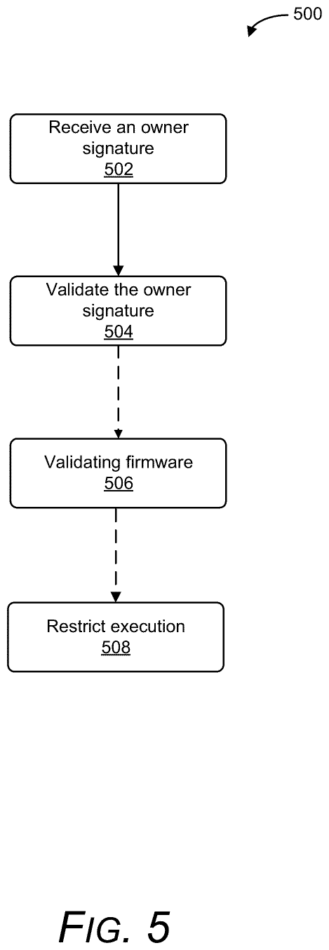

In FIG. 5, an example method 500 for restricting execution of software in accordance with one or more implementations of the present disclosure is shown. The method 500 may be performed by the host computing device 102. In block 502, a designee signature 290 is received. The designee signature 290 may be based on the installed firmware 122 or the revised firmware 124. It should be appreciated that the designee signature 290 may be based on a private key. The private key may be assigned to the host during manufacture and stored in the ROM 110 or elsewhere. In another example, the private key may be assigned to the current designee 132 and stored securely by the current designee 132.

In block 504, the designee signature 290 is validated by the host computing system 102. The designee signature 290 may be validated in a variety of ways and through multiple processes and steps. As one non-limiting example, the designee signature 290 may be validated by calculating a hash of the designee public key 232 and decrypting an endorsement of the designee public key 232 by the host public key 214 to ensure that the designee public key 232 was endorsed by the host private key 210. The endorsement may be stored in the previous-designee entry 230 associated with the designee public key 232.

Alternatively or additionally, the designee signature 290 may be validated by calculating a hash of the ROM extension memory 352 and decrypting an endorsement of the ROM extension memory 352 with the host public key 214. The host public key 214 may be used, directly or indirectly, to validate any endorsement by the host private key 210 of the designee public key 232. The host private key 210 may endorse the designee public key 232, the ROM extension memory 352, other memory associated with the host computing device 102, or any combination thereof to validate the designee public key 232.

The designee signature 290 may be validated by calculating a hash of the revised firmware 124. The designee signature 290 may be decrypted with the designee public key 232. Any uniqueness algorithm or cryptographic mechanism may be used for hashing, encrypting, and decrypting discussed herein (e.g., cyclic redundancy check, checksums, keyed cryptographic hash functions, unkeyed cryptographic hash functions). The uniqueness algorithm may be performed on the revised firmware 124 along with other information or any portion thereof In an example, if the hash of the revised firmware 124 is equivalent (e.g., equal to) to the decrypted designee signature 290 and the decryption key used is authenticated by the host public key 214, the firmware 124 is considered authentic and is able to be executed on the integrated circuit 120.

In block 506, the revised firmware 124 is validated according to a designee public key, such as the designee public key 232. As an example, the designee public key 232 may be stored on the NVM 112 and accessed to decrypt the designee signature 290 or the entire firmware 124. A comparison may be executed to validate that the firmware 124 was encrypted by the designee 132 or signed by the designee 132. As such, the firmware 124 may be validated through a process that includes two public key validations. One of the validations may ensure that the designee public key 232 is valid and signed by the host private key 210 using a root signature. Such a validation may be performed by the host public key 214. Another of the validations may ensure that the firmware 124 signed by the designee 132 using the designee private key 234. As such, the process allows a transfer of ownership by the host computing device 102 to varying designees 132 through a root of trust stored within the host computing device 102.

In block 508, execution of the revised firmware 124 may be restricted by the integrated circuit 120 or another implement. As an example, the integrated circuit 120 may include an enable bit based on the logical result of the comparison or comparisons discussed above. If the hash and the decrypted designee signature 290 are unequal, execution of the firmware 124 on the integrated circuit 120 is prevented. Execution restriction of firmware may be extended to any firmware of the host computing device 102. Power to the integrated circuit may be removed.

The host private key 210 may be based on the integrated circuit 120, other integrated circuits disposed on the host computing device 102, a random number, any other information related to the manufacturer (e.g., model, software, or circuitry of the host computing device 102), or any combination thereof The host private key 210 may be substantially unique to the host computing device 102, or unique for a set of host computing devices 102 (e.g., model type, model number). A model number may be various designations by a manufacturer to identify a product. A model type may be various designations by a manufacturer to identify groups of products or model numbers.

Absolute uniqueness may not be numerically achieved by a numerical algorithm, and substantially unique may include uniqueness of a particular set of similar host computing devices 102 having unique host private keys 210 within the set. Indeed, in one other example, manufacturer intent, rather than implemented reality, may define substantial uniqueness.

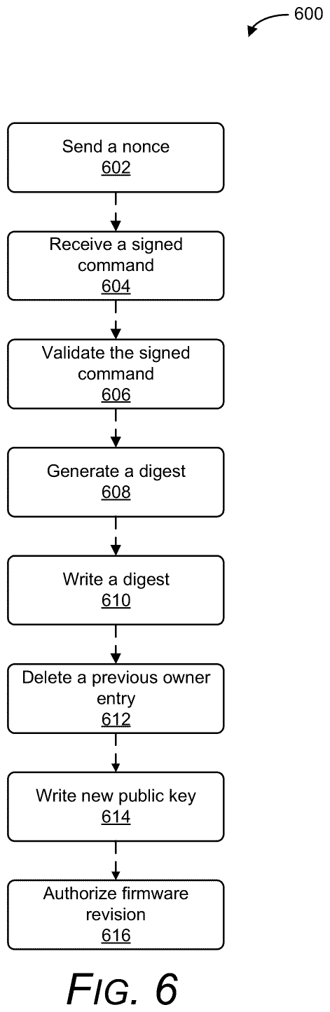

Turning to FIG. 6, an example method for activating a designee in accordance with one or more implementations of the present disclosure is illustrated. In block 602, a nonce is sent. The nonce may be a one-time-use number and may be based on a clock of the host computing device 102. The nonce may be based on a deterministic random-bit generator of the host computing device 102. The host computing device 102 may send the nonce in response to an ownership transfer request. In an example, the nonce is dispatched with a device identifier associated with the host computing device 102. The device identifier, the nonce, and the request are then signed by the host computing device 102. As a further example, assume that a new designee may request ownership transfer. This new designee can be an entity different from the manufacturer and current designee, such as when a new designee is necessary, due to an end-of-life or end-of-support issuance.

In block 604, a signed unlock command is received. The host computing device 102 may request the unlock command A cloud-based application or another implement may receive the unlock command request sent by the host computing device 102. The current designee 132 may be granted access to the unlock command request and may authorize transmission of an unlock command signed by the designee private key. The signed unlock command authorizes the host computing device 102 to unlock the ownership status of the NVM 112 to write a current-designee entry 240 or another entry corresponding to the new designee.

In block 606, the host computing device 102 validates the signature of the unlock command by the current designee 132, as signed by the designee private key 234. Validation may include comparing a hash of the unlock command and a decrypted signature of the unlock command The validation of the signed command unlocks the NVM 112 to allow the current-designee entry 240 to be written.

In block 608, the host computing device 102 computes the current-designee digest 412. The current-designee digest 412 may be a message authentication code (MAC), keyed-hash message authentication code (HMAC), or another type of integrity and authenticity function. The current-designee digest 412 may be based on a symmetric key managed by the cryptographic library 212. The symmetric key may be known to the new designee or the device manufacturer to enable the secure transfer of issued public and private keys. The symmetric key is provisioned during manufacture and stored in the write-once storage of the ROM 110. In the instance where the previous-designee digest 410 is associated with a previous-designee entry 230, the current-designee digest 412 associated with the current-designee entry 240 may be based on the previous-designee digest 410 in an effort to bind the key to the custody chain.

In block 610, the current-designee digest 412 is written to the NVM 112. Upon writing the current-designee digest 412, the host computing device 102 may re-sign the manifest 220, the ROM extension 354, the rest of the flash banks 350, or any combination thereof In block 612, the previous-designee entry 230 is deleted, erased, or otherwise eliminated from the manifest 220. Upon deleting the previous-designee digest 410, the host computing device 102 may re-sign the manifest 220, the ROM extension 354, the rest of the flash banks 350, or any combination thereof

In block 614 a new public key may be written to the public-key repository 406 and associated with the current-designee entry 240. The new public key may be the designee public key 232. As such, in block 616, the new public key may be used to authorize a firmware revision using methods discussed throughout this disclosure. It should be appreciated that any of these steps, referred to herein as blocks, may be omitted, rearranged, or duplicated.

### Conclusion

Although implementations of techniques for, and apparatuses enabling, trusted computing for digital devices have been described in language specific to features and/or methods, it is to be understood that the subject of the appended claims is not necessarily limited to the specific features or methods described. Rather, the specific features and methods are disclosed as example implementations enabling trusted computing for digital devices.

1. A method comprising:
receiving signature associated with a designee of a host computing device, the signature generated according to firmware associated with an integrated circuit of the host computing device and a first private key of a first asymmetric key pair; and
validating the signature based on a second asymmetric key pair having a second private key and a second public key , the second private key stored in write-once memory of the host computing device.

2. The method of claim 1, wherein the validating the signature is further based on a first public key associated with the firmware by the second public key.

3. The method of claim 2, further comprising validating the firmware with the first public key.

4. The method of claim 1, further comprising restricting execution of the firmware based on the signature and the second private key.

5. The method of claim 4, wherein the restricting execution is further according to a root signature defined by the second private key.

6. The method of claim 1, wherein:
the second private key is written to the write-once memory during manufacture of the host computing device; or
the signature is endorsed by the first private key.

7. (canceled)

8. The method of claim 1, wherein the second private key is derived from information associated with the integrated circuit and is unique to the host computing device with regard to other computing devices having a same model type as the host computing device.

9. The method of claim 1, wherein the second private key is derived from information associated with a controller of the host computing device and is unique to the host computing device with regard to devices having a same model as the host computing device.

10. A method comprising:
sending a nonce with a device identifier unique to a second private key stored in write-once memory of a host computing device;
receiving a signed command based on the nonce and the device identifier; and
validating the signed command according to a first public key associated with a designee of the host computing device.

11. The method of claim 10, further comprising:
generating an authentication code based on a symmetric key and a new designee identifier associated with a new designee;
writing the authentication code to an additional entry of a read-only memory extension; and
deleting a previous-designee entry associated with the designee from the read-only memory extension.

12. The method of claim 11, further comprising:
writing a new public key of a new asymmetric key pair to the additional entry; or
sending a new private key of the new asymmetric key pair to the new designee.

13. (canceled)

14. The method of claim 12, further comprising:
receiving a signature generated according to the new private key associated with the new designee; and
validating the signature based on a second asymmetric key pair having the second private key and a second public key.

15. A computer-readable medium comprising instructions that, responsive to execution by a processor of a host computing device, direct the processor to implement operations comprising:
receiving a signature associated with a designee of the host computing device, the signature generated according to firmware associated with an integrated circuit of the host computing device and a first private key of a first asymmetric key pair; and
validating the signature based on a second asymmetric key pair having a second private key and a second public key, the second private key stored in write-once memory of the host computing device.

16. The computer-readable medium of claim 15, wherein the validating the signature is further based on a first public key associated with the firmware by the second public key.

17. The computer-readable medium of claim 16, wherein the operations further comprise validating the firmware with the first public key.

18. The computer-readable medium of claim 15, wherein the operations further comprise restricting execution of the firmware based on the signature and the second private key.

19. The computer-readable medium of claim 18, wherein the restricting execution is further according to a root signature defined by the second private key.

20. The computer-readable medium of claim 15, wherein:
the second private key is written to the write-once memory during manufacture of the host computing device; or
the signature is endorsed by the first private key.

21. The computer-readable medium of claim 15, wherein the second private key is derived from information associated with the integrated circuit and is unique to the host computing device with regard to other computing devices having a same model type as the host computing device.

22. The computer-readable medium of claim 15, wherein the second private key is derived from information associated with a controller of the host computing device and is unique to the host computing device with regard to devices having a same model as the host computing device.
